(19) United States
(12) Patent Application Publication
(10) Pub. No.: US 2024/0029500 A1
(43) Pub. Date: Jan. 25, 2024

(54) AUTOMATED SQUARES GAMING

(71) Applicant: SQUARE ACTION HOLDINGS, LLC, North Palm Beach, FL (US)

(72) Inventor: Matthew DELIA, North Palm Beach, FL (US)

(73) Assignee: SQUARE ACTION HOLDINGS, LLC, North Palm Beach, FL (US)

(21) Appl. No.: 18/224,787

(22) Filed: Jul. 21, 2023

Related U.S. Application Data
(60) Provisional application No. 63/391,587, filed on Jul. 22, 2022.

(51) Int. Cl. G07F 17/32

(52) U.S. Cl. CPC G07F 17/3211; G07F 17/3223; G07F 17/3288; G07F 17/3276

(57) ABSTRACT

An automated number squares game method and system may enable the implementation of open and/or closed number squares games, in which users are enabled to purchase squares in a matrix representing possible event outcomes. Number squares may be generated automatically, without human intervention, as previous number squares are filled completely or to a predetermined amount. These and other capabilities may be implemented by providing graphical user interfaces (GUIs) to users and game administrators. In one aspect, a party may be provided with an administrative capability to run a private number squares game.

### CROSS-REFERENCE TO RELATED APPLICATION

The present application claims priority to U.S. Provisional Patent Application No. 63/391,587, filed on Jul. 22, 2022, which is incorporated by reference herein in its entirety.

### BACKGROUND

The present disclosure may relate to techniques for implementing an automated number squares-type game.

Numerical squares are a known type of pool game. In such a game, a 10×10 grid is created based on a game played between two teams; this is typically the National Football League's Super Bowl® game, and the game is commonly referred to as the “Super Bowl® squares” game. The squares are based on the final score of the Super Bowl® game, with the numbers along the left side of the grid representing the last digit of the final score of one team and the numbers along the top of the grid representing the last digit of the final score of the other team. A pool participant pays for one or more squares, which represent a last digit of the final score of one team and a last digit of the final score of the other team. The game may be “open” or “closed.” In an “open” game, the numbers along the left side and top of the grid are shown, and the pool participant knows the combination she is paying for when purchasing a square. In a “closed” game, the numbers along the left and the top are scrambled and are not known to the pool participants until after they are revealed by the pool organizer (typically after the entire board of squares has been purchased or after the game begins).

This game is generally implemented manually, usually on paper, but possibly using a computer program to create the grid (and then print it out). Someone will prepare the grid and will offer people the chance to buy squares. This may limit the extent of the game, in terms of number of participants.

Additionally, the participants are limited to those to whom the person organizing the game chooses to offer to allow to play.

Factors like these limit the extent and flexibility of the game, and it may be desirable to have other ways to implement the game to achieve greater flexibility, such as, but not limited to, by permitting more participants and other ways to attract participants.

### BRIEF DESCRIPTION OF THE DRAWINGS

Various aspects of the present disclosure will now be presented in conjunction with the accompanying drawings, in which:

FIGS. 1A-1D show conceptual examples of game boards;

FIG. 2 shows an example of a first graphical user interface according to aspects of the present disclosure;

FIGS. 3A-3C show example flowcharts of gaming operation according aspects of the present disclosure;

FIGS. 4A-4D show an example of a second graphical user interface according to aspects of the present disclosure;

FIGS. 5A and 5B depict a conceptual example of a game board and a zoom feature according to various aspects of the present disclosure;

FIG. 6 shows an example of an administrative graphical user interface according to aspects of the present disclosure;

FIG. 7 shows examples of ways in which users may enter games according to some aspects of the present disclosure;

FIGS. 8-10 depict example system block diagrams according to various aspects of the present disclosure; and

FIGS. 11A-11D show an example of a graphical user interface according to various aspects of the present disclosure.

### DETAILED DESCRIPTION OF ASPECTS OF THE DISCLOSURE

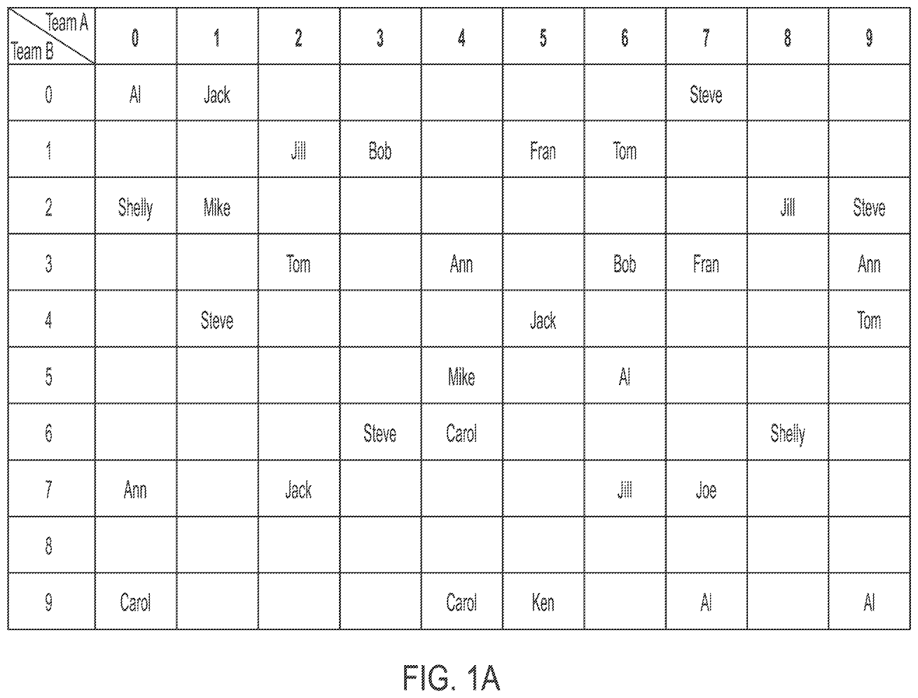

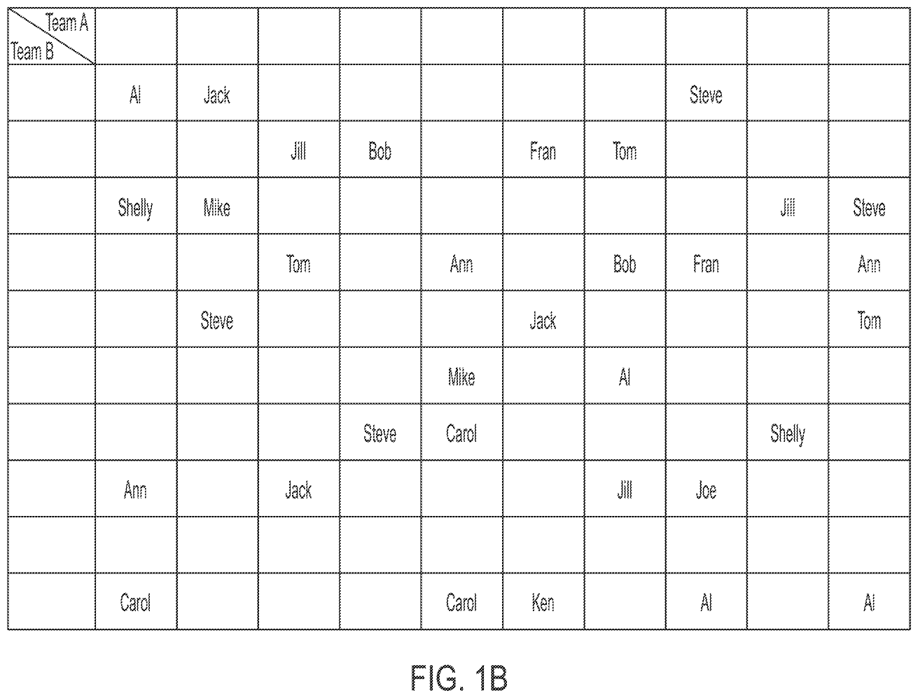

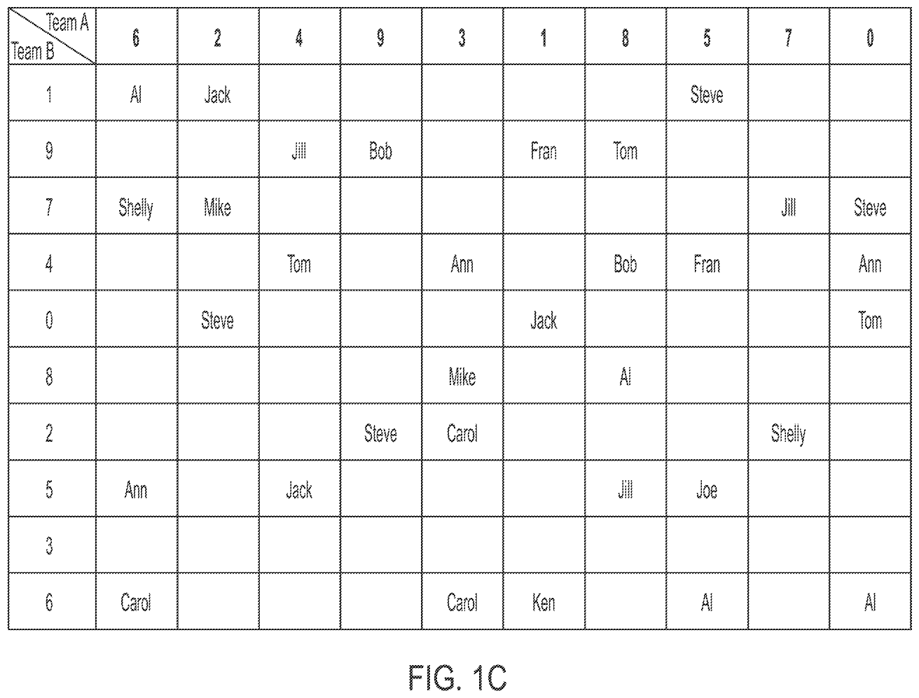

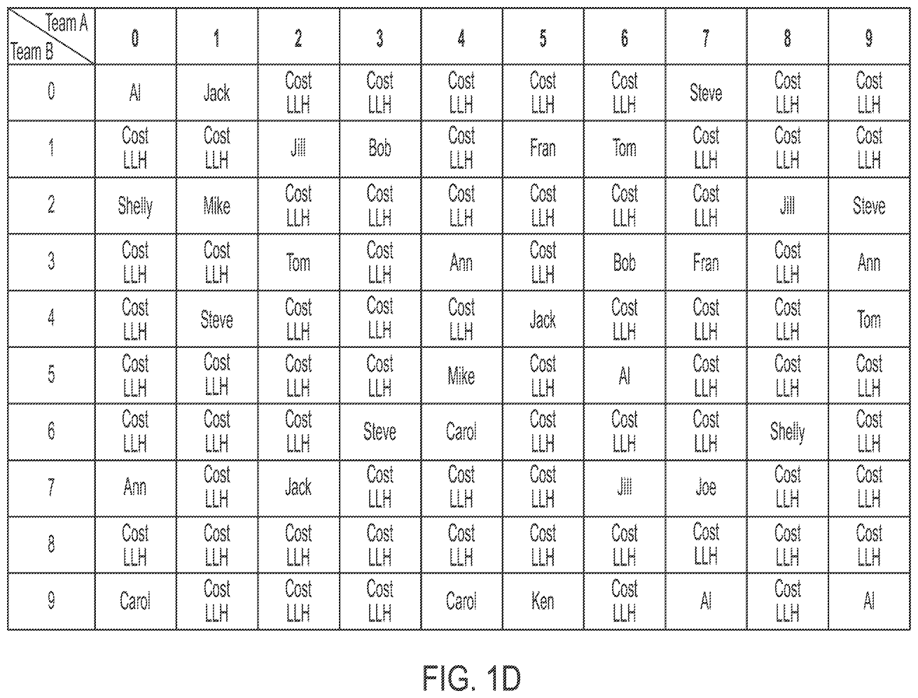

FIGS. 1A-1C show conceptual diagrams of what game boards may look like. FIG. 1A may represent a game board in an “open” game. Suppose Team A and Team B are playing each other in a game, such as the Super Bowl® game. A “game master”/pool organizer offers people the opportunity to select the squares in the 10×10 interior grid, which has the digits 0-9 along the top, representing the final digit of Team A's final score, and the digits 0-9 along the left, representing the final digit of Team B's final score. Hence, each square in the 10×10 interior grid represents a combination of a final digit of Team A's final score and a final digit of Team B's final score. For example, the square purchased by Al (purchasers' names or pseudonyms or other indicia of identity (e.g., registration numbers, screen names, etc.) are typically shown in the purchased squares) to the right of 0 and underneath 0 represents a final score, such as Team A Team B 10, in which the final digits of both teams' scores are zeros. Similarly, Jill has purchased the square to the right of 7 and underneath 6, representing a final score in which Team A's score ends in 6 and Team B's score ends in 7, such as Team B 37, Team A 26. FIG. 1A represents what may be shown to people, who may then purchase one or more squares whose final digit combination they are aware of when they select squares to purchase. The winner may be determined by examining 68 combination of final digits of the final score of the game for Teams A and B.

In a variation of the open game of FIG. 1A, FIG. 1D illustrates an open game in which the various squares may be purchased for different amounts of money. The cost of a given square may depend on a statistical likelihood that the scores of Teams A and B may end in a given combination of digits. Therefore, different squares may have different costs, and a user may purchase squares of lower likelihoods/lower costs and/or squares of higher likelihoods/higher costs. The costs may be shown, as in the example of FIG. 1D; the likelihoods (“LLH” in FIG. 1D) may also be shown, according to an aspect of the present disclosure. Costs may be expressed in terms of actual currency, cryptocurrency, chips or points (i.e., game currency or currencies), etc. Likelihood may be expressed in any of a number of ways, including, but not limited to, odds, a percentage, a fraction, etc.

FIGS. 1B and 1C may be used to represent a “closed” game. As previously noted, in a “closed” game, the players do not know what combination of final digits of final scores are represented by any given square in the 10×10 internal grid. People purchase squares “blindly,” without knowing what final digits for Teams A and B are represented by the squares, as represented conceptually in FIG. 1B. After sale of squares has ended (e.g., but not limited to, when all squares have been purchased, when the pool organizer decides sales are ended, or after the game), the left-hand column and top row that show the digits may be revealed, and the players then know what final digit combination(s) they have purchased. For example, Al, who purchased the upper left square, discovers that he has purchased the combination in which Team A's score ends in 6 and Team B's score ends in 1, and as a result, if the outcome is Team A 26, Team B 11, Al would win the game.

As noted above, in a conventional game, to which FIGS. 1A-1D are not limited, the boards would be presented (manually (e.g., in person)) to the prospective participants, and they would be given an opportunity to purchase one or more squares. The pool organizer would then fill in the names/IDs of the people who have purchased the respective squares.

According to aspects of the present disclosure, various aspects of a squares game board may be automatic. That is, game boards may be automatically generated and offered to prospective players, and other aspects and enhancements to the idea of a squares game may be implemented automatically.

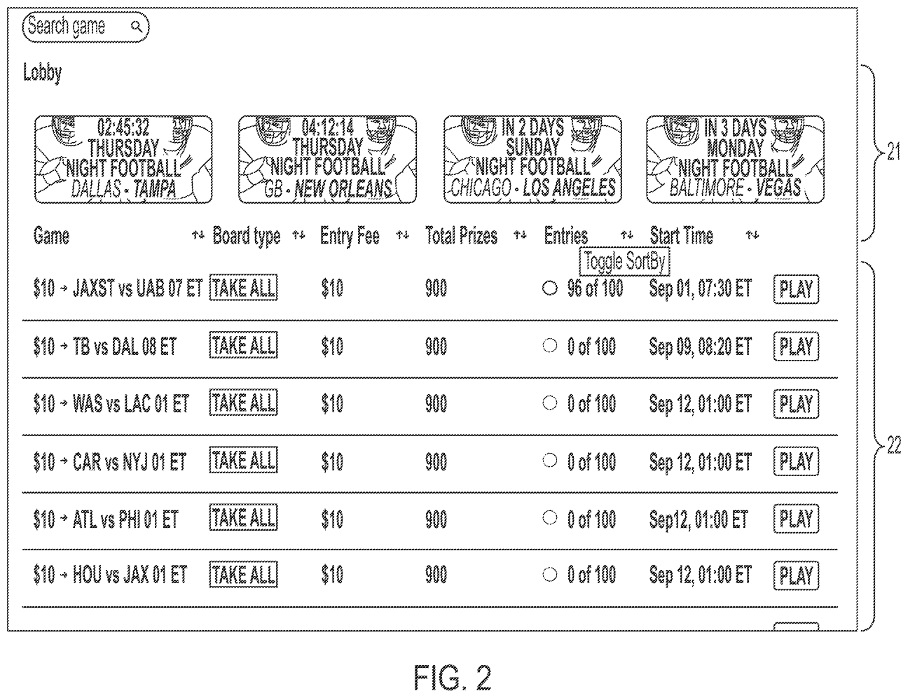

FIG. 2 shows an example of a graphical user interface that may be presented to a user, according to various aspects of the present disclosure. Squares games according to aspects of the present disclosure may be computer-implemented and accessed by means of a graphical user interface (GUI). The GUI shown in FIG. 2 may be an initial GUI accessed by a user, e.g., upon accessing a web site (which may require creating an account and/or logging in) or a kiosk (not shown). The GUI shown in FIG. 2 may be thought of as a “lobby.” FIG. 2 depicts an array 22 of squares games that the user may currently choose to enter. The lobby of FIG. 2 may also show upcoming squares games 21 that may become available at a later time or date. The array 22 may include such information as the actual game/sporting event, the board type (e.g., “take all” (in which the winner may receive the entire prize offered for winning (e.g., money, game tokens, or other type of prize) or other prize-winning criterion in which not only the winner but some other subset of players are awarded prizes), an entry fee per square, an amount or description of the prize(s) to be awarded, a number of entries in a current game board, and/or further information about the game. A “play” or similar button may be provided next to each squares game to permit the user to press or click on the button to indicate that the user would like to enter that squares game. Buttons next to various types of game information may allow the user to sort the games according to a given type of game information (e.g., alphabetical listing of games, numerical order of entry fees, etc.).

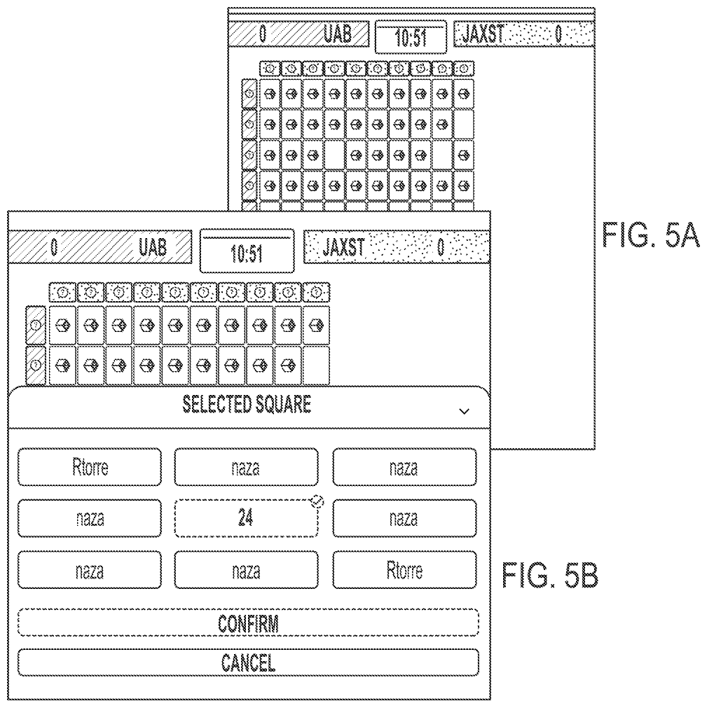

When the user clicks on/presses the “play” or similar button, the user may be presented with a squares game board that may be similar to one shown in FIG. 1A or FIG. 1B; a further example is shown in FIG. 5A (which shows an example of a “closed” board). The user may then indicate how many squares she wants to purchase in that squares game board. According to one aspect of this disclosure, the user may be permitted to select the desired square(s) (e.g., by clicking on or otherwise selecting square(s) not yet taken by another user). According to another aspect of the present disclosure, the user may have the option to indicate how many squares he wishes to purchase, and the game system may randomly choose that number of squares from among the available squares and assign them to the user.

The user may then be permitted to exit to the lobby GUI (FIG. 2) to choose one or more further squares games to enter. A user may enter as many different squares games as the user wishes, with possible limitations on games that will be discussed below.

As users purchase squares in a board, the GUI may indicate to the user viewing the GUI which squares are available, which squares have been purchased, and which squares the user viewing the GUI has selected and/or purchased. This may be done by shading, hatching, outlining, coloring, etc., and the GUI may include a key that indicates to the user what is meant by each type of shading, hatching, outlining, coloring, etc.

Users may pay for their entries via an established account, which may be linked to a credit card or bank account, or they may be permitted to enter a payment card number for a one-time purchase. Alternatively, in, e.g., a casino setting, a user may enter tokens or a card containing credits purchased at the casino into a kiosk on which the game is presented.

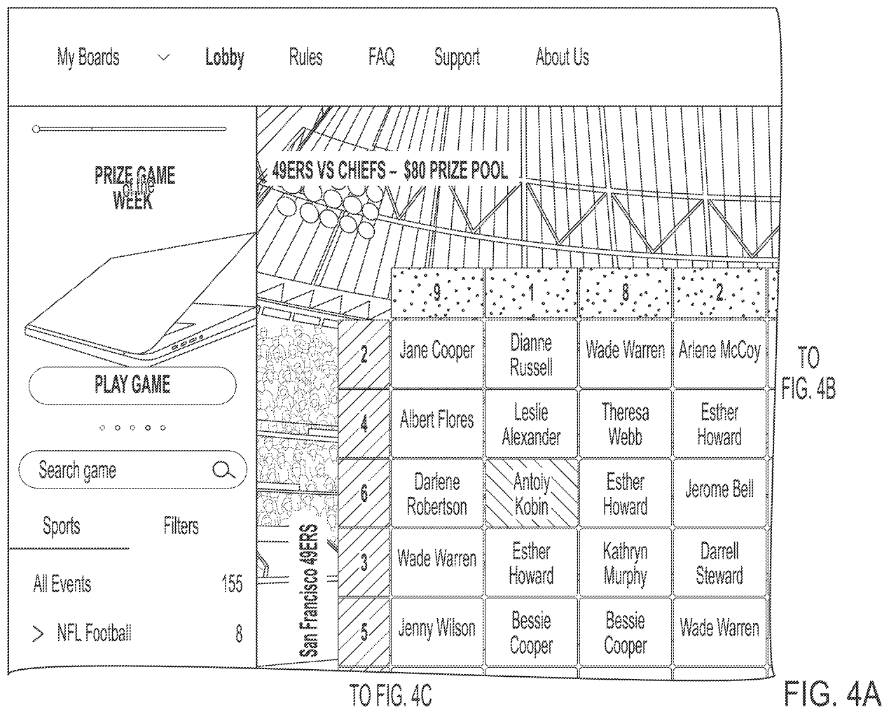

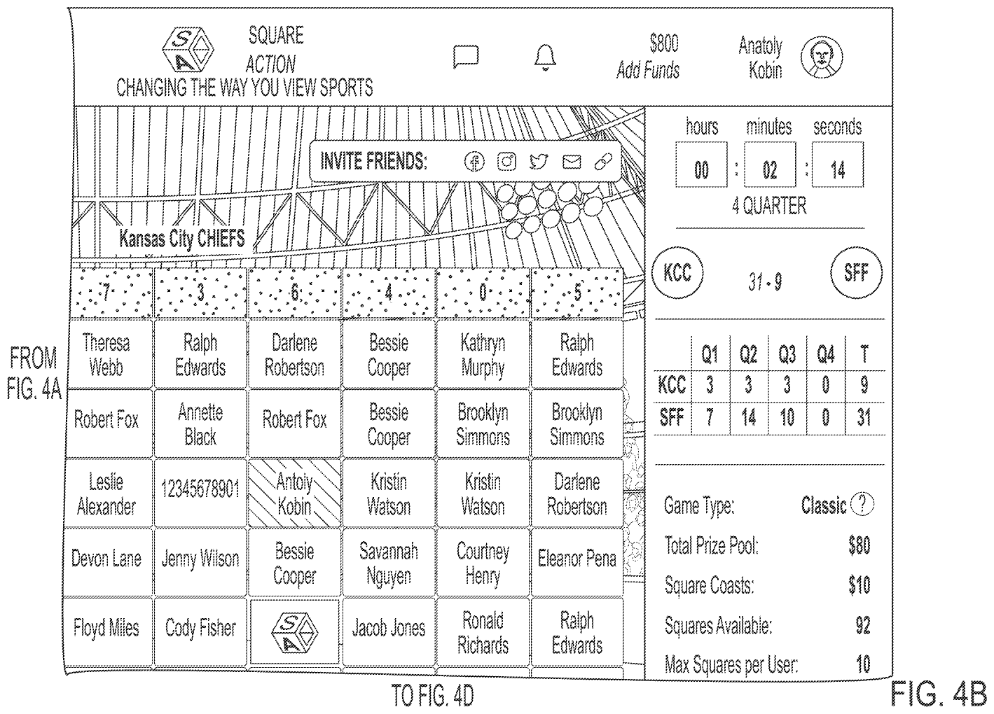

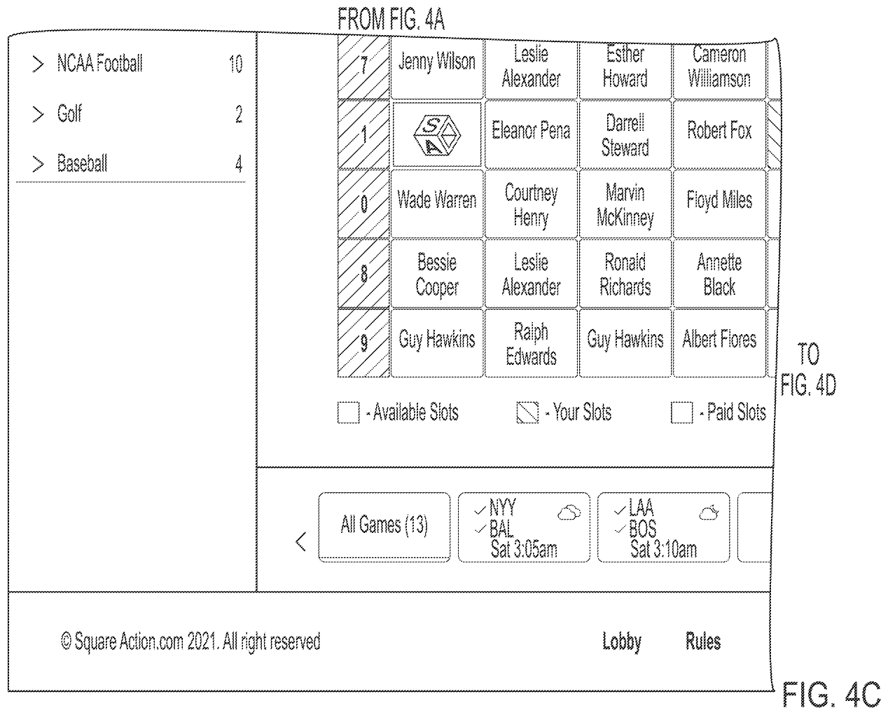

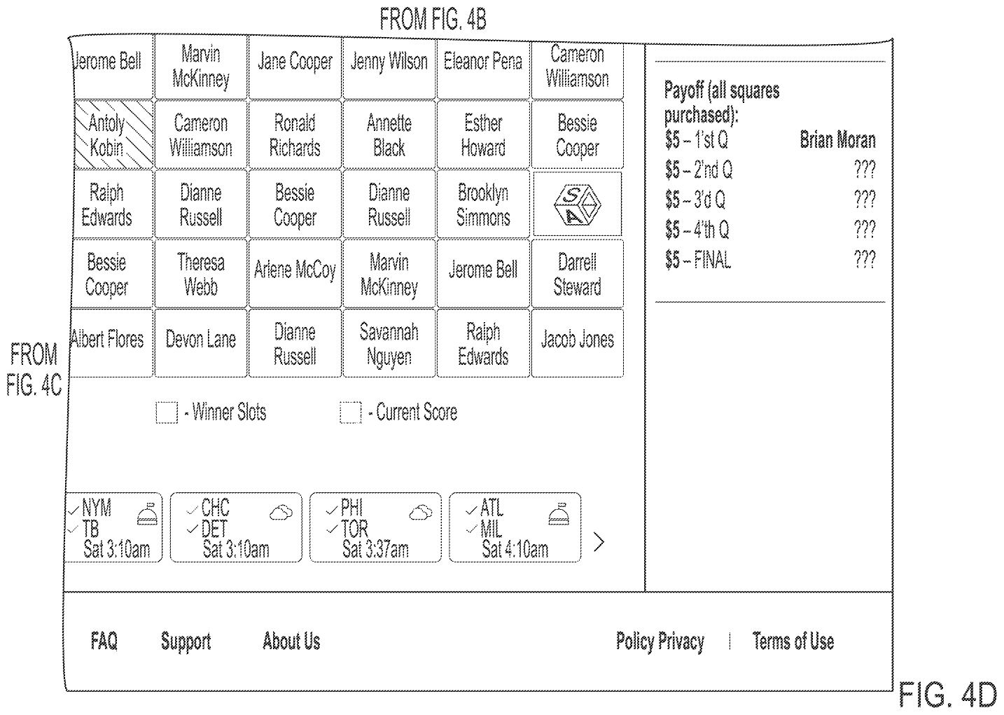

According to an aspect of the present disclosure, the squares game system may permit a game administrator to set a maximum number of squares that may be chosen out of any 10×10 board. Alternatively, the system may permit all squares to be chosen. If the system sets a maximum that is less than 100 (i.e., all squares), the non-chosen squares may be filled with a symbol or icon representing the system, as shown in FIGS. 4A-4D.

Another feature according to an aspect of the present disclosure is that once a board is full or reaches its maximum number of squares, a new game/board may be generated for the particular sporting event associated with the actual game/sporting event. In this way, there may be a theoretically unlimited “inventory” of available squares for purchase for a given actual game/sporting event.

In addition to “closing” a board when it is full or reaches a maximum occupancy (i.e. of chosen squares), a board may be terminated at or before the beginning of the actual game/sporting event. According to one aspect of this disclosure, if a board is terminated without filling/reaching the maximum, or without reaching some predetermined minimum occupancy (e.g., but not limited to, 60%-75%), users who have selected that board for play may receive refunds or credits, and the board may be eliminated. In the case of having at least the minimum occupancy, the remaining portion of the board may be filled with symbols or icons representing that the squares were not taken by any user and that no user wins if the outcome lies on the squares having the symbol/icon. This minimum occupancy may be manually set by a system administrator.

According to various aspects of the present disclosure, the system operator may make profits in one or both of two ways. In a first way, the operator may award one or more prizes for the board having a total value less than the total of the entry fees paid for the squares of the board; this may be referred to as the “rake.” In a second way, the operator may award no prize in a board that is not fully occupied (or equivalently, occupied by the operator), should the outcome of the actual game/event result in an unoccupied square being the winner.

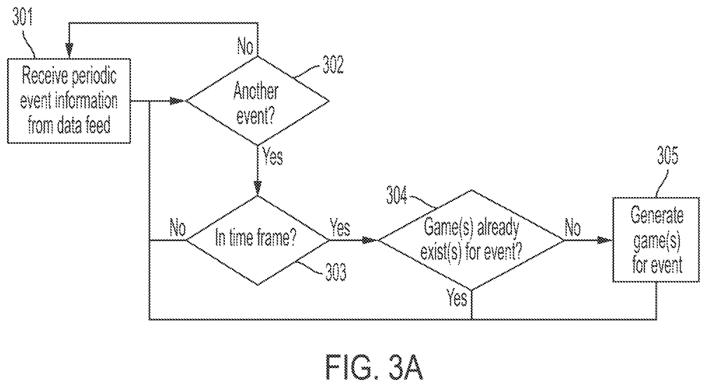

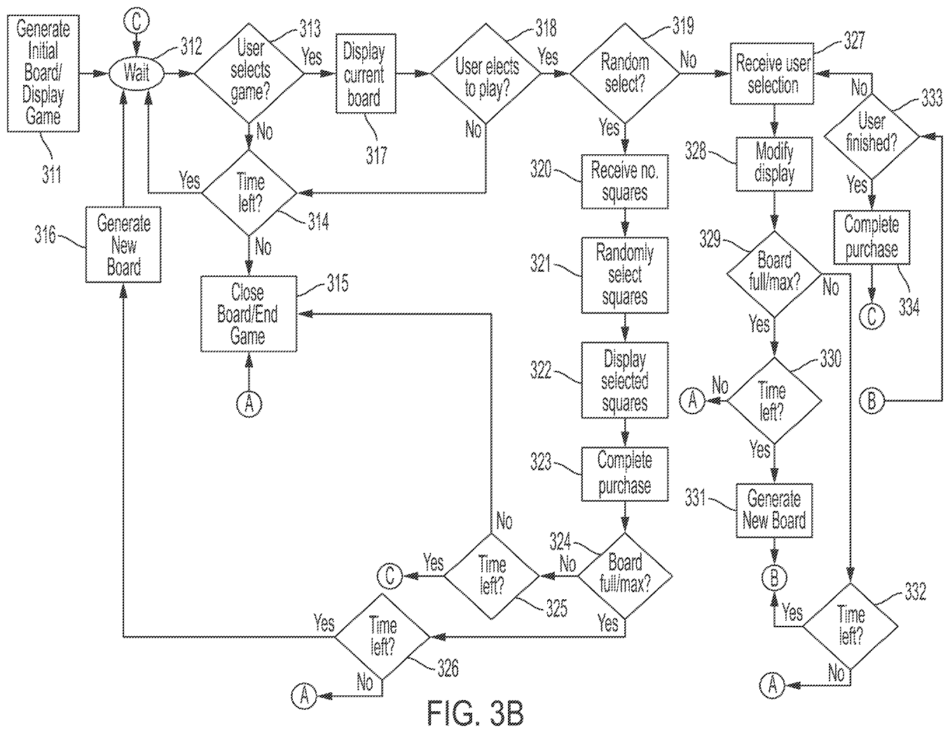

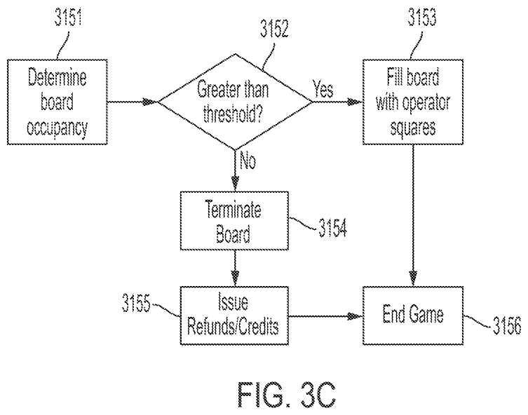

FIGS. 3A-3C depict conceptual flowcharts providing examples of how aspects of the above procedures may be implemented. FIG. 3A may address an example process of how the system may implement new games, corresponding to different events (e.g., but not limited to, sporting events). The system may receive 301 information about different events from a data feed. This may be sequential or a list, and it may be provided periodically, at regular time intervals. The system may determine 302 if there is another event in the sequence or list. If not, process may end, and the system may return to block 301 to await reception via the data feed. If yes, the process may proceed to determine 303 if the event falls in a time frame during which the system has been programmed to create new games. For example, if the event lies too far in the future or if it will commence too close to the creation of a game, the system may choose not to create a game and may return to block 302 to determine whether there is a further event to examine. The parameters regarding the time frame may be preset by a system administrator of the game system. If the event falls within the time frame, the system may then determine 304 if one or more games have already been created for the event. If yes, then the system may return to block 302 to determine whether there is a further event to examine. If not, then the system may proceed to generate 305 one or more games relating to the event. Although not shown, it is also possible that the system may determine if creating one or more games for the given event is desired and may elect not to create any games for the event. The desirability of creating one or more squares games for particular events or types of events may be considered by the system operator, and the system may be set not to create games for certain events or types of events preset by a system administrator.

In addition to automatically creating games, the presence of the live feed may permit the system to account for changes in the events, e.g., but limited to, schedule changes. Accordingly, parameters associated with a given game, such as time remaining for game boards to be filled (see below) may be automatically adjusted. This may also be useful in manual creation/provisioning of games, as will be discussed below.

It is noted that more than one type of game may be created for a given event, and although the “squares game” is known surrounding the National Football League's Super Bowl® game, it is not limited to this game, nor is it limited to professional football games, or even college or high school football games. Games also need not be limited to focusing on the final score of a football or other game. For example, other sports, such as baseball, basketball, hockey, soccer, etc., may have quantities whose last digits may be compared. For example, basketball game scores, soccer or hockey shots on goal, golfers' scores in a tournament, numbers of pitches thrown by starting pitchers in a baseball game, etc., may form bases for squares games; these are only examples, and the invention is not limited to any of these particular examples. Additionally, squares games based on any particular measure need not be limited to final results; for example, squares games may be created for each quarter of a football game or basketball game or numbers of cumulative pitches thrown by the pitchers in a baseball game or numbers of shots on goal in a period of a hockey game; the invention is not limited to any of these examples.

FIG. 3B moves on to a flowchart that may illustrate how a game is created and run, according to various aspects of the present disclosure. Once it is determined to create a game, an initial game board may be created (e.g., as in FIG. 1B), and the existence of the game may be made displayed to users 311, e.g., by displaying the game in a “lobby,” such as, but not limited to, that shown in FIG. 2. Once a game is created and made available 311, the system may wait 312 for a user to select the game 313. Block 313 may be visited periodically, according to a predetermined time interval, and may also be triggered by a user selecting the game. If no user has selected the game during the predetermined time interval, the system may test 314 if there is time remaining in the game. A game may be ended 315 at a predetermined time, set by the system administrator for the type of game or for a particular instance of a type of game (e.g., some time period before the event begins, when the event is scheduled to begin, at or prior to the commencement of some subset of the event if the game focuses on a subset of the event, etc.; these are to be considered non-limiting examples). The process of block 315 will be discussed in further detail below, in conjunction with FIG. 3C. On the other hand, if it is determined 314 that there is time remaining in the game, the process may return to block 312.

If it is determined 313 that a user has selected the game, the current game board may be displayed 317; FIGS. 4A-4D provide a non-limiting example of such a display. The system may then determine 318 if the user has elected to enter the game. If not, the process may branch to block 314 to determine if there is time remaining. If yes, then the user may be presented with an option 319 to have the system randomly select a user-entered number of squares or to select squares manually. If the system determines 319 that the user would like to have the system randomly select squares, the system may prompt the user for and subsequently receive 320 the number of squares that the user wishes to purchase in the board. The system may then proceed to randomly select 321 the number of squares that the user wishes to purchase. There are many known ways in which to implement random selection based on a number of remaining available squares in the board. One example, to which the invention is not limited, is to have each remaining square be represented by a number or a numerical interval and to generate a set of random numbers equal to the number of squares the user wishes to purchase, by means of which the squares for the user are randomly selected; again, the invention is not thus limited. After the squares are selected 321, the display may be updated to show 322 the squares now belonging to the user. This may be done by means of shading, hatching, coloring, outlining, etc. The user's purchase may then be completed 323, which may involve charging the user or the user's account, receiving a number of gaming tokens/chips, etc. After the purchase has been completed 323, the system may then examine the board to determine 324 if it is full or has reached a preset maximum permitted occupancy (as discussed above). If the board is determined 324 not to be full or not to have reached its maximum occupancy, the process may proceed to determine 325 if there is time remaining in the game. If yes, then the process may return to block 312 to await further users. If not, then the process may proceed to block 315 to close the current board and end the game. On the other hand, if the board was determined 324 to be full or at its maximum occupancy, the process may continue to determine 326 if there remains time left in the game. If yes, then the process may proceed to create a new board 316 and wait 312 for a further user. If not, then, again, the process may proceed to close the current board and end the game 315.

If it is determined 319 that the user has not chosen to have random squares assigned to her for purchase, the system may receive 327 a user selection of a square. This may be done by means of a touch screen, mouse, keypad, or other selection devices/means. Upon receiving 327 the user selection of a square, the system may update 328 the game board to indicate that the user has selected the square; again, this may be done by using shading, hatching, coloring, outlining, etc. Following selection 327 and display 328, the process may test 329 to determine if the game board is full or has reached its maximum occupancy. If yes, then the process may determine 330 if there is time remaining in the game. If not, the process may proceed to close the board and end the game 315 (while not explicitly shown, this may include completing the user's purchase prior to closing the board and ending the game). If there is time remaining in the game, a new board may be generated 331, and the user may be prompted to determine 333 whether or not she would like to select a square in the new board. If yes, then a new user selection may be received 327, and the process may proceed as previously discussed. If not, then the user's purchase may be completed 332, and the process may branch back to waiting 312 for another user.

If, on the other hand, the board was not determined 329 to be full or to have reached its maximum occupancy, the process may determine 332 if there is time left in the game. If yes, the process may branch to block 333 to determine if the user would like to make a further selection in the present board, and process proceeds as discussed above. If not, then the current board is closed, and the game is ended 315.

FIG. 3C shows a flowchart of an example process that may be used to implement block 315, closing the board and ending the game. The process may begin by determining 3151 a board occupancy of the last board (block 315 may represent the completion of the game, so the last board offered to users may thus be examined). The board occupancy may be expressed as a number from 0 to 100 or as a percentage of squares purchased. This may be compared 3152 with a minimum board occupancy threshold. The minimum board occupancy threshold may be predetermined by the system operator and set by a system administrator. If the board occupancy is determined 3152 to meet or exceed this preset threshold, the board is filled with “house” squares (i.e., the operator is given possession of the remaining available squares) 3153, and the game is ended 3156. If the minimum board occupancy threshold is not met or exceeded 3152, the board may be terminated 3154. This means that the board may be discarded. Accordingly, any users who selected squares in the board may be given refunds or credits 3155. The game may then be ended 3156.

According to a further aspect of the present disclosure, the operator may wish to maintain multiple active boards for a given game at a given time and to allow users to access all of these active boards when purchasing squares. The number of active boards for any given game may be preset by an administrator. The user may be presented with multiple boards in a GUI or may view one of the multiple active boards at a time. This may introduce the further options into the flowchart of FIGS. 3A-3C of: (a) permitting the user to purchase random randomly selected squares obtained considering all active boards of the game; (b) permitting the user to purchase randomly selected squares obtained from a user-selected subset of the active boards of the game; and (c) permitting the user to select squares from any or all of the active boards of the game. All of these options would only require straightforward additions of these options, which amount to modifications of the options already shown in the flowchart. As part of maintaining multiple active boards, the occupancy of each active board may be monitored, so the inquiry blocks in the flowchart would need to be applied multiple times to account for each active board, and the rules for permissible maximum occupancy and for closing a board would continue to apply as explained above (e.g., when there is no time remaining, all active boards are checked for occupancy to determine whether to fill a given board or to terminate the board, as in FIG. 3C). A difference may be that once a board is closed, thus resulting in fewer than the predetermined number of active boards being available, a new board may be generated.

During the squares game, according to various aspects of the present disclosure, the system may permit the user to view a GUI such as that shown in FIGS. 4A-4D. FIGS. 4A-4D show the 10×10 board of a squares game in which the user has one or more entries. As noted above, the board may include a symbol or icon in each square unoccupied by any user. The user's entries may be highlighted, e.g., by shading, hatching, outlining, coloring, etc. The square of the current winning user may be highlighted differently, as may be multiple winning squares, if the squares game allows for multiple winners. A key may be shown to indicate to the user which type of highlighting indicates which aspect of the game (e.g., user's squares, winning squares, etc.). The system may be tied into an information provider that may allow the board to be updated, e.g., at predetermined time intervals. The GUI may also show current information about the actual game/sporting event and/or about other ongoing actual games/sporting events. The latter may include buttons and/or arrows to permit the user to scroll through actual games/sporting events and/or to choose actual/games sporting events of different types about which the user may wish to obtain current information. Again, these may be updated, e.g., at predetermined time intervals, based on an incoming information feed from an information provider.

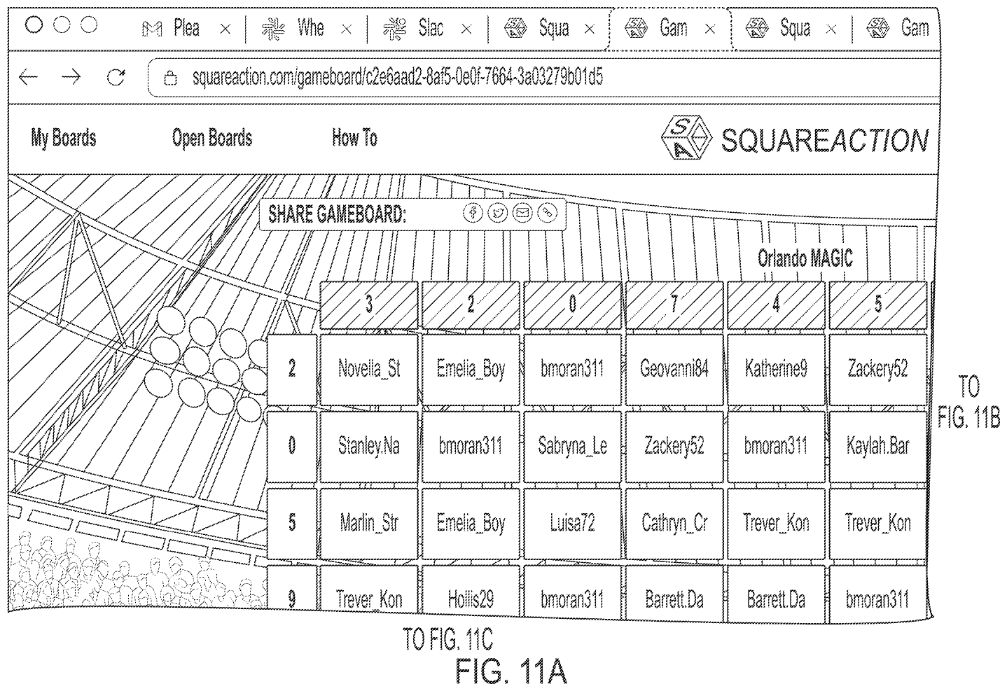

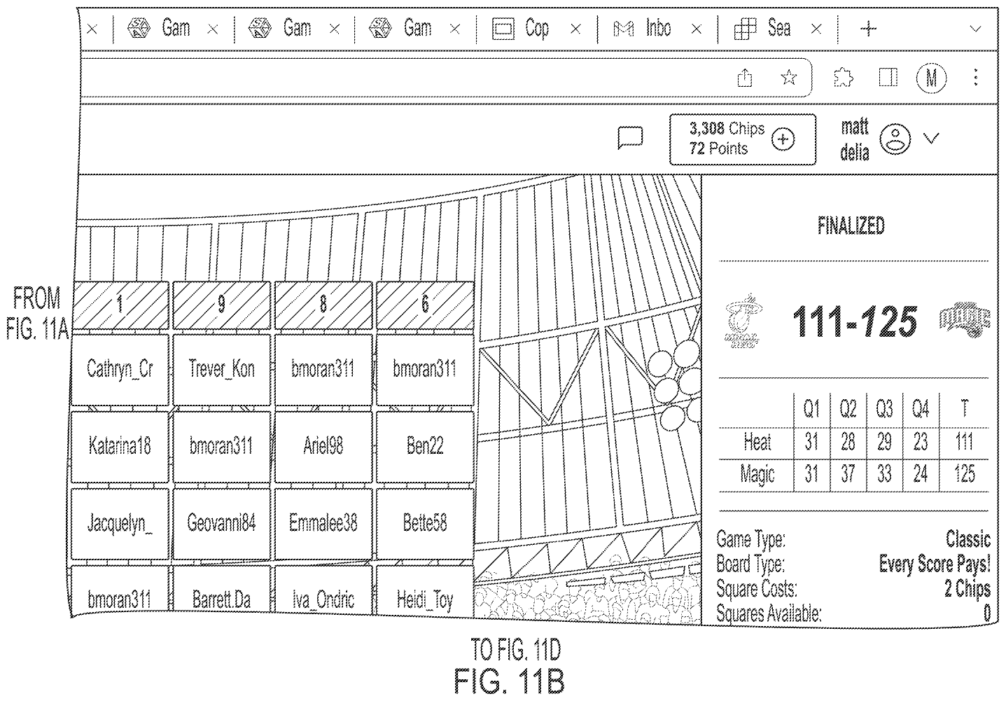

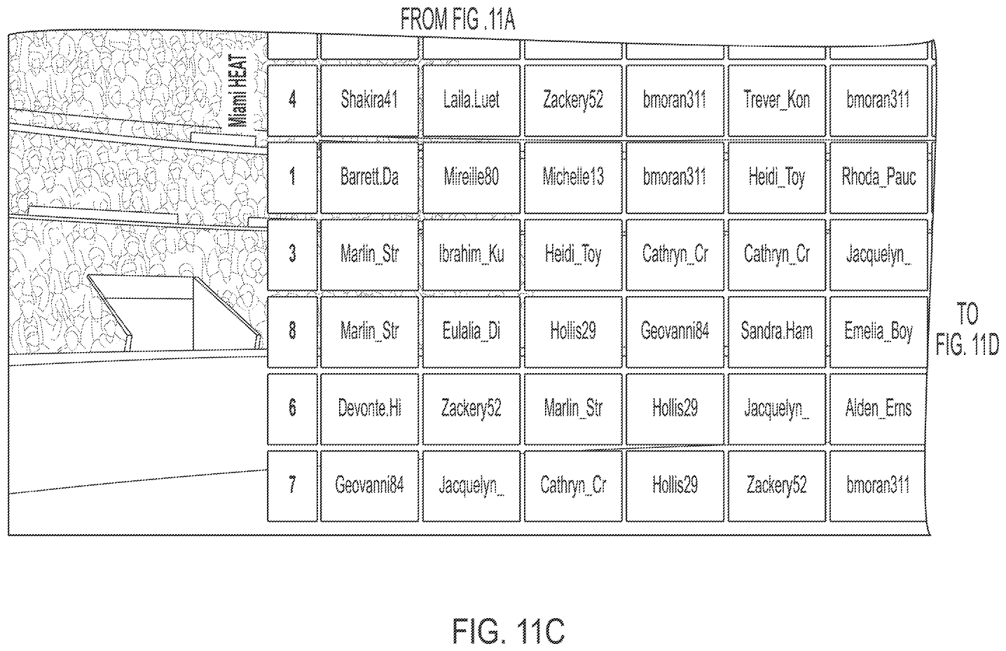

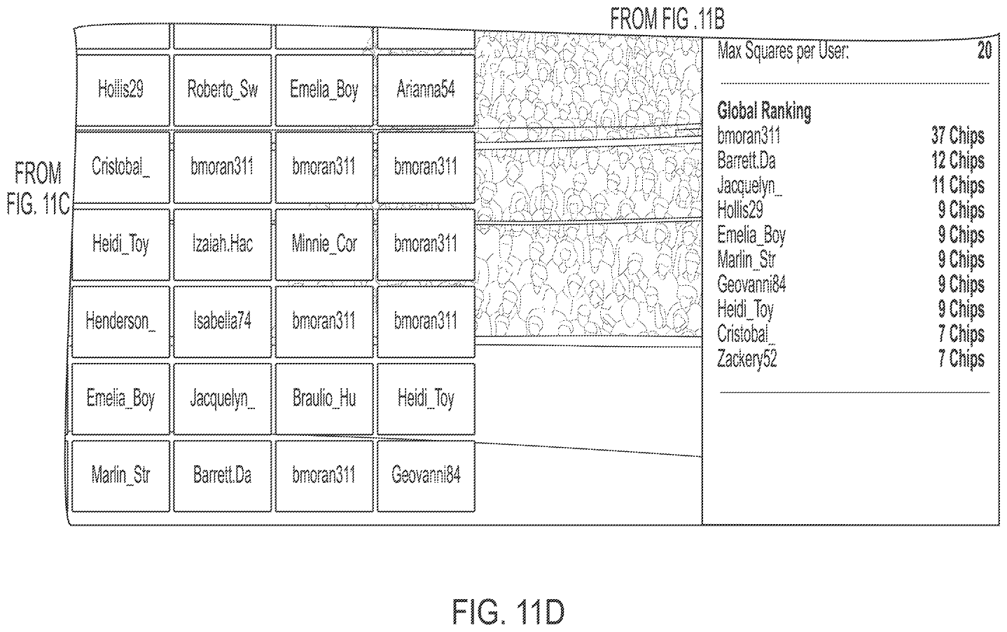

FIGS. 11A-11D show a further example of a game GUI according to various aspects of the present disclosure. In this example, a variation on the games discussed above, users may purchase squares, similarly to as in the preceding discussions. However, in this variation, prizes are awarded for each scoring change. For example, in a basketball game, each time a basket is scored, the final digit pair of scores of the two teams will change, and a prize may be awarded to the purchaser of the square representing the new final digit pair. Similarly, in football, any time a team scores, the final digit pair will change, and a prize may be awarded to the holder of the corresponding box. This may work similarly for other sports, such as baseball, soccer, hockey, etc. The GUI, as in the example of FIGS. 11A-11D, may show a cumulative total of the winnings of the various users; in this example, a number (in this case, two) of chips may be awarded to the user who has purchased the box containing the new final digit pair every time the score changes. As users watch the GUI of FIGS. 11A-11D, the box representing the current (new) final digit pair of the score may be highlighted (e.g., using a color, border or border color, flashing, etc.), and the users' winnings (shown at the right side in this non-limiting example) may be updated.

As noted above, FIG. 5A shows an example of a game board that may be presented in a GUI according to aspects of the present disclosure. The game board of FIG. 5A is “closed,” in that the numbers along left-hand side and upper side of the 10×10 grid are not shown when the user is given the opportunity to purchase squares.

In addition to being shown on a computer display, kiosk, smart television screen, or other large device, the GUI may be tailored to accommodate smaller displays, such as those of smartphones, PDAs, tablet devices, etc., by implementing an automatic zoom feature, demonstrated in FIGS. 5A and 5B. The user of such a device may enter a “mobile version” of the game lobby by activating an application on the device or going to a web site that detects the type (size) of the device and presents the mobile version of the lobby, which may include features like those of the regular lobby. However, when the device user selects a game to enter, there may be a difficulty in selecting a particular square due to the size of the display, particularly if the user is using a finger to make selections. To assist the user, when the user touches or otherwise selects a square in the board of FIG. 5A, the device may detect the location at which the board was touched. This location may be relayed back to a server or processed by an application on the mobile device, and the server or application may send back a zoomed/enlarged portion of the board including the location at which the board was touched, an example of which may be represented in FIG. 5B. This zoom feature may permit the user to verify that he has selected the square he desired to select and to change his selection to the desired square if the system detected a different square. In addition to ensuring that the user is able to select the desired square for purchase, the enlarged display may also allow the user to see the names (or screen names or other identity indicia) representing users who have selected squares in the board.

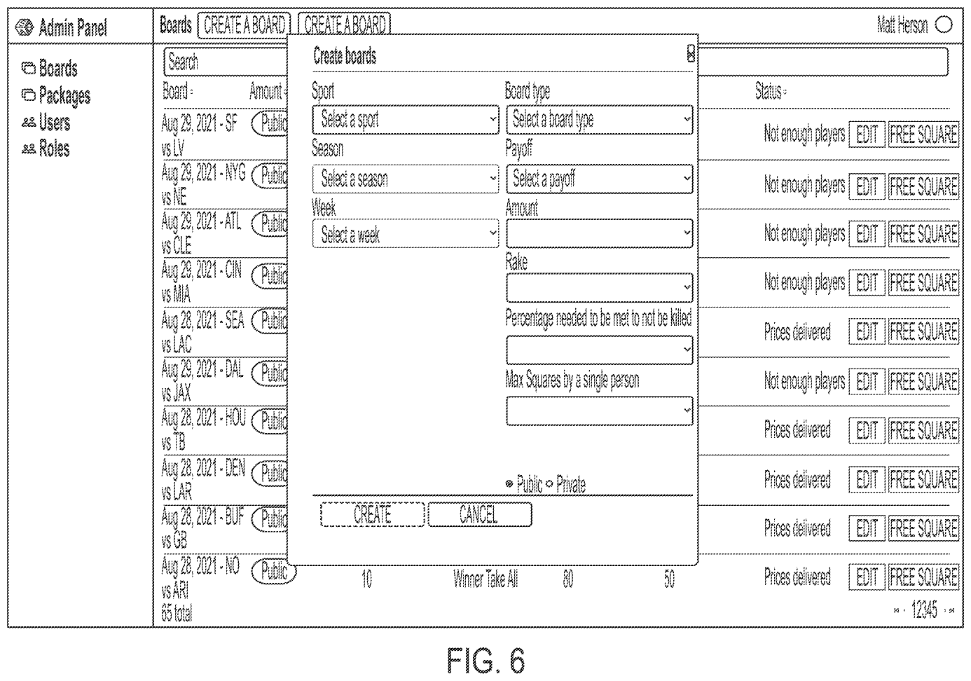

FIG. 6 shows an example of an administrative GUI according to aspects of the present disclosure. The GUI of FIG. 6 may be used by an administrator to manually create games. The administrative GUI of FIG. 6 enables an administrator to select an event (e.g., based on a given sport, week, etc.) and to set parameters for a board to be generated for a game. Event information may, as in the automatic generation process described above, provide available events and associated information, as well as updated event information. The various entries may be selected using dropdown menus, keyboards, buttons, keypads, or other appropriate input/output (I/O) devices. Once created, the game may be displayed in user lobby GUI, such as that of FIG. 2, which may permit users to play.

According to a further aspect of the present disclosure, private parties, such as bars, restaurants, stadiums, clubs, individuals, etc., may be provisioned to run their own private games. In this case, the administrative GUI may include a “public/private” selection, as shown in FIG. 6. By selecting “private,” the administrator may thus indicate that the game should not be displayed in a public game lobby but is rather intended for access only by a private group. While not shown, a private game may be set up for access using a unique QR code, URL, etc., which may be provided to the private party (e.g., a bar, restaurant, etc.) to provide to the (prospective) players or may be provided directly to the (prospective) players. The system described above may then be used to administer the private game according to the manually-set parameters from the administrative GUI of FIG. 6.

As an alternative, according to another aspect of the present disclosure, the administrative GUI may be provisioned to a private party by the system operator. This may allow private parties to create their own games, with their own desired parameters, which may then run on the system of the system operator, which may be as described above.

Hence, there may be multiple ways in which games may be actualized using the systems and techniques according to aspects of the present disclosure. To summarize the examples discussed above, these may include direct-to-consumer (e.g., game operator may offer users to play via a website, kiosk, app, etc.) or via private parties (e.g., game operator may support private games, as discussed above). Another possibility would be to offer the games through a “sponsor” who pays the game operator to support a game and provides prizes to players (e.g., this may be a promotion for a commercial enterprise). Yet another example may be to license use of the game to casinos, cruise ships, etc.

The above discussion has discussed “purchasing” squares in games. There are a number of ways in which this may work. According to various aspects of the present disclosure, some games may be played using “chips,” while others may be played using “points.” “Chips” may be purchased by users and may have cash value. They may be used to purchase squares in “chip” games and may be won in “chip” games. The value of a “chip” may be predetermined by the system operator.

“Points,” on the other hand, may have no cash value and may be used to obtain squares in “points” games. “Points” may not be purchased; rather, they may be given to users, for example, in promotions, as incentives (e.g., for logging in and/or playing), as a bonus for purchasing “chips,” and similar activities. They may be won in “points” games.

A given user may have both “chips” and “points.” Accordingly, according to an aspect of the present disclosure, a user's account may include two “wallets,” one for “chips” and one for “points.”

There may be other ways to play in “chip” games. For example, a person desiring to obtain a square may make a request by mail to enter a given game and may be assigned a random square in the game if the request is received by a predetermined deadline. In a variation, if the deadline is not met, the person may be assigned a square in a different game at the discretion of the system operator.

Furthermore, according to another aspect of the present disclosure, the system operator may set amounts of “points” that may be accumulated to permit a user to purchase a square in a “chip” game.

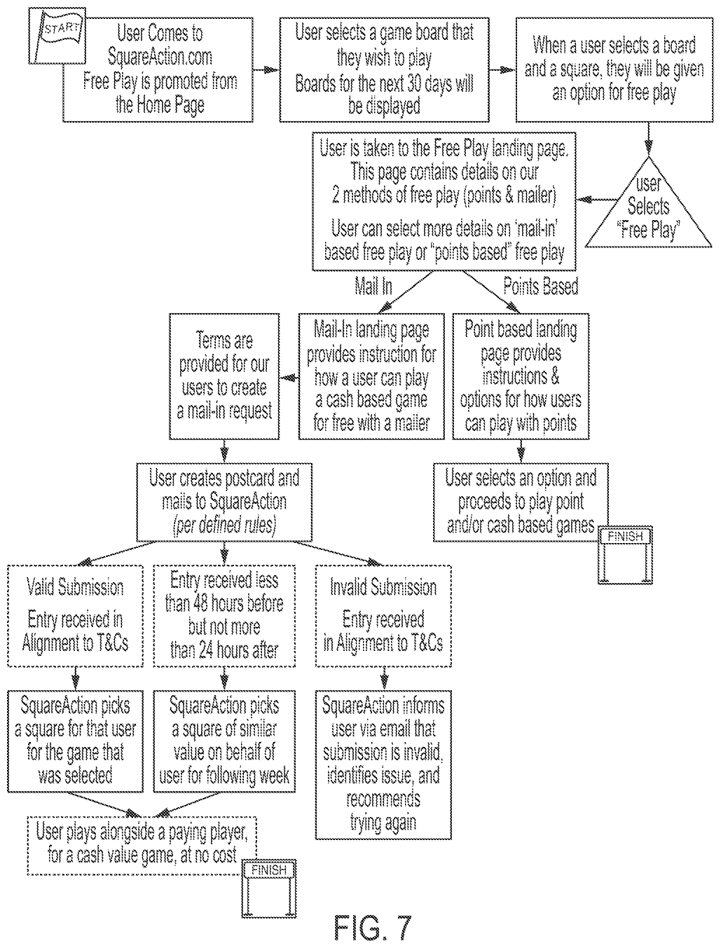

These examples, and further information, are depicted in the flowchart shown in FIG. 7.

Although “points” may have no cash value, as noted above, in some example scenarios, the system operator may allow a user to accumulate a sufficient preset number of “points” to obtain a square in a “chip” game. A system operator may also, for example, have a “game shop” in which “points” may be exchanged for items (e.g., but not limited to, hats, t-shirts, etc.).

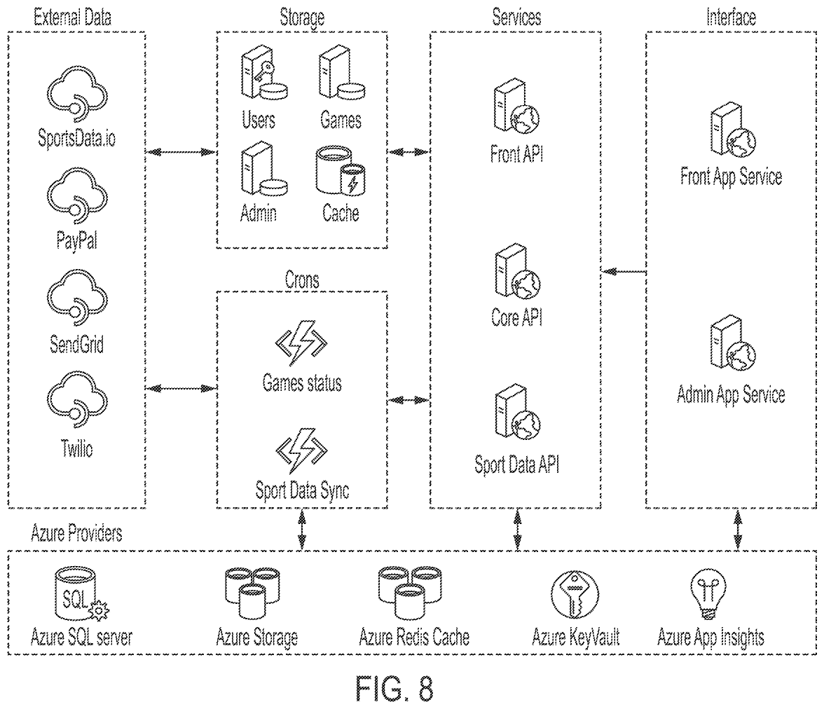

FIGS. 8-10 provide conceptual block diagrams of examples of system architectures that may be used to implement a squares game system according to various aspects of the present disclosure. As shown in FIG. 8, in one example to which the present invention is not limited, a cloud-based architecture may be used, for example, using a cloud service such as, but not limited to, Microsoft® Azure® cloud services. The cloud-based architecture may include one or more processors that run software contained in memory that implements various functions, e.g., as described above. There may be further memory devices, outside of the cloud service, that may be used to store various types of data, e.g., as shown in FIG. 8. The various GUIs provided to the system administrator and/or the user may provide I/O interfaces with the cloud-based services and/or non-cloud-based components. External I/O interfaces, such as data feeds, connections with payment systems, etc., may be provided to allow communication with components external to the cloud-based service, and some or all of the data received via these interfaces may be saved in storage external to the cloud-based service and/or may be forwarded for providing to the user GUI and/or the administrator GUI.

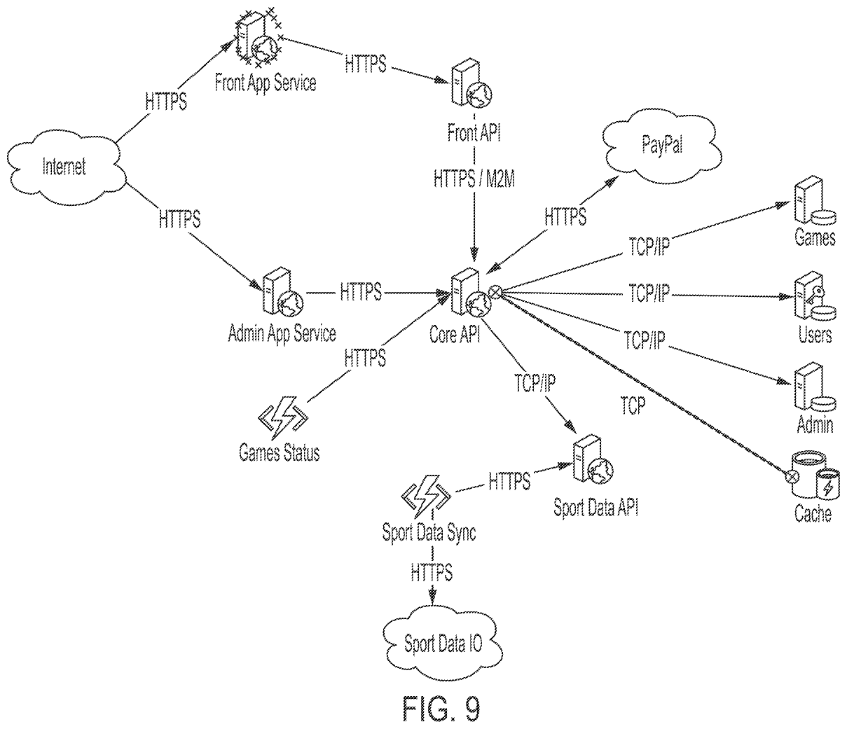

FIG. 9 provides a further conceptual block diagram that provides further details of interactions among various system components according to aspects of the present disclosure. As shown in FIG. 9, various communication protocols may be used in communication between various system components.

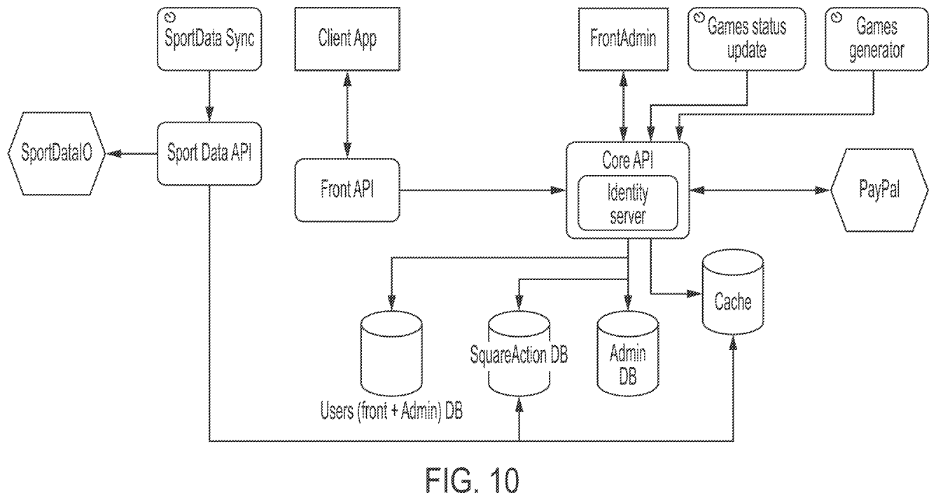

FIG. 10 may represented a higher-level system block diagram, according to aspects of the present disclosure. FIG. 10 further reflects that the system need not be implemented using a cloud service but may also be implemented using non-cloud-based computing components. As shown, the system may include at least one server (e.g., “identity server”) that may include one or more processors, system memory, I/O interfaces, etc. The at least one server may interact with other servers and/or with various databases/other memory resources. As noted above, a data feed, e.g., from sportdata.io, may provide event information via an I/O interface (e.g., a communication module, such as an Internet chip/card, transceiver, etc., which may be hard-wired or wireless). Information from the data feed may be stored for use by the system. The server(s) may generate the user GUI and the administrator GUI, which may permit interaction via various application programming interfaces (APIs). The system may also include one or more communication I/O interfaces (as above) that may permit connection with one or more payment services, e.g., but not limited to, PayPal® payment service.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. An automated number squares game method, including:
generating, by a server, and causing to be displayed on one or more user-accessible display devices, a number square graphical user interface (GUI) for a game event related to a real-world event, wherein a game event corresponds to numerical quantities generated during the real-world event, the number square GUI including a first number square, wherein each square of the first number square represents a pair of digits, each digit of the pair of digits being an integer from 0 to at most 9, wherein no pair of digits is repeated within the first number square;
enabling one or more users, via the at least one user-accessible display device, to select and purchase one or more squares of the first number square using the number square GUI; and
automatically generating, by the server, and displaying on the one or more user-accessible display devices, a second number square to display using the number square GUI if the first number square reaches a maximum number of squares permitted to be purchased, and enabling the one or more users to select and purchase one or more squares of the second number square using the number square GUI.

2. The method according to claim 1, further comprising:
automatically generating, by the server, and displaying on the one or more user-accessible display devices, a further number square to display using the number square GUI upon a previous number square reaching the maximum number of squares permitted to be purchased, wherein the further number square represents a third or greater number square and the previous number square represents the second or greater number square preceding the further number square; and
enabling one or more of the users to select and purchase one or more squares of the further number square using the number square GUI.

3. The method according to claim 1, further comprising, prior to said generating the number square GUI:
receiving at the server real-world event information from a data feed;
determining by the server if a number squares game has already been generated for a game event related to the real-world event; and
generating, by the server, one or more number squares games corresponding to one or more game events corresponding to the real-world event if a number squares game has not previously been generated for the real-world event.

4. The method according to claim 1, wherein said enabling one or more users to select and purchase one or more squares of the first number square using the number square GUI includes:
displaying on the one or more user-accessible display devices a game GUI that enables the one or more users to select a game event from among one or more active game events, wherein an active game event is a game event for which a number squares game exists and is still accepting purchases of squares; and
generating on the one or more user-accessible display devices the number squares GUI corresponding to the game event selected by the one or more users.

5. The method according to claim 1, wherein the digits forming the pairs of digits are displayed along edges of the number square or within the individual squares of the number square of the number square GUI.

6. The method according to claim 1, wherein, for a given number squares game, each pair of digits represents a score or other set of occurrences within a game event with which the number squares game is associated, and wherein a prize is awarded to a user whose square corresponds to a particular pair of digits every time the score or other set of occurrences within the game event changes to match the particular pair of digits.

7. The method according to claim 1, wherein said enabling one or more users to select and purchase one or more squares of the first number square using the number square GUI includes:
in response to a particular user of the one or more users attempting to select a particular square on a particular one of the one or more user-accessible display devices, causing a display of the particular user-accessible display device to zoom in on a region surrounding the particular square to enable the particular user to verify that the particular user's desired square was chosen or to enable the particular user to correct the selection if the particular square selected is not the particular user's desired choice.

8. The method according to claim 1, further including providing an administrative interface to a party to enable the party to run a private number squares game.

9. A non-transitory machine-readable medium containing executable instructions designed to enable one of more processors to implement operation comprising the method according to claim 1.

10. An automated number squares game system including:
at least one processor;
the non-transitory machine readable medium of claim 8, wherein the non-transitory machine-readable medium is communicatively coupled to the at least one processor; and
at least one input/output device communicatively coupled to the at least one processor, wherein the at least one input/output device also includes a communication interface to at least one communication network.

11. An automated number squares game system including:
one or more servers configured to communicate with one or more user-accessible devices via one or more communication networks, wherein the one or more user-accessible devices include respective displays and user input capabilities; and
one or more non-transitory storage devices communicatively coupled to the one or more servers;
wherein at one of the one or more non-transitory storage devices contains executable instructions designed to cause the one or more servers to execute operations to implement the method according to claim 1, and
wherein the one or more servers include(s) a communication interface that enables communication with an event feed that includes information regarding real-world events that the one or more servers is/are able to use to generate number squares games.

12. The automated number squares game system according to claim 11, wherein the one or more servers is/are cloud-based, and wherein at least one of the one or more non-transitory storage devices is cloud-based.

13. The automated number squares game system according to claim 11, wherein the one or more servers is/are configured to provide to the one or more user-accessible devices remote client application services, and is/are configured to provide an administrator interface, either via an input/output device directly coupled to the one or more servers or via a device communicatively coupled to the one or more servers via a communication network.

14. The automated number squares game system according to claim 11, wherein the one or more servers is/are further communicatively coupled to at least one payment service.

15. The automated number squares game system according to claim 11, wherein the one or more servers is/are configured to provide an administrative interface to a party to enable the party to administer a private number squares game.

16. The automated number squares game system according to claim 11, wherein the one or more non-transitory storage devices include a user database, an administrative database, and a game database.
